(19) United States
(12) Patent Application Publication
(10) Pub. No.: US 2025/0207944 A1
(43) Pub. Date: Jun. 26, 2025

(54) HIERARCHICAL MAP-BASED LOCALIZATION

(71) Applicant: Cisco Technology, Inc., San Jose, CA (US)

(72) Inventors: Domenico Ficara, Essertines-sur (CH); Amine CHOUKIR, Lausanne (CH); Pascal THUBERT, Roquefort les Pins (FR)

(21) Appl. No.: 18/392,550

(22) Filed: Dec. 21, 2023

(51) Int. Cl. G01C 21/00

(52) U.S. Cl. CPC G01C 21/3878; G01C 21/3896

(57) ABSTRACT

In one embodiment, a method is disclosed comprising: determining a hierarchical map of localization measurement accuracy for an environment; determining a first location of a mobile device within the environment; causing the mobile device to navigate to a second location within the environment and selected based on the hierarchical map that provides increased localization measurement accuracy over the first location; and calibrating, based on a localization measurement for the mobile device acquired at the second location, navigation operations for future movements of the mobile device.

### TECHNICAL FIELD

The present disclosure relates generally to computer networks, and, more particularly, to hierarchical map-based localization.

### BACKGROUND

Automation is on the rise across the industrial landscape. This rise in automation is accompanied by a corresponding rise in the necessity for reliably and accurate device localization. Automated devices require an accurate understanding of their location in order to effectively perform their assignments. For example, mobile devices involved in the execution of industrial operations may rely on positional awareness in order to successfully perform different operations. Approaches to achieving positional awareness include the use of wireless signal metrics to determine the position of a mobile device. Unfortunately, industrial environments are often replete with conditions, obstacles, signal interference, environmental materials, etc. that significantly degrade the accuracy and/or reliability of such metrics. Often, only portions of an industrial environment are able to provide access to the data and/or services necessary to deliver these metrics. As a consequence, mobile devices are presently unable to accurately and/or reliably perform their assigned high precision industrial operations.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 is a schematic block diagram of an example simplified computer network;

FIG. 2 illustrates an example network device/node;

FIG. 3 illustrates an example of an architecture for hierarchical map-based localization among mobile devices in an environment;

FIGS. 4A-4C illustrate examples of a hierarchical map for hierarchical map-based localization among mobile devices in an environment; and

FIG. 5 illustrates an example simplified procedure for hierarchical map-based localization.

### DESCRIPTION OF EXAMPLE IMPLEMENTATIONS

### Overview

According to one or more embodiments of the disclosure, a technique is provided for hierarchical map-based localization of mobile devices. The hierarchical map-based localization of a mobile device such as a robot may include determining, by a device, a hierarchical map of localization measurement accuracy for an environment. The device may determine a first location of a mobile device within the environment. The device may cause the mobile device to navigate to a second location, selected based on the hierarchical map, within the environment. The second location may be a location that provides increased localization measurement accuracy over the first location. Then, the device may calibrate navigation operations for future movements of the mobile device based on a localization measurement for the mobile device acquired at the second location.

Other embodiments of the present disclosure may be discussed in the detailed description below, and the summary above is not meant to be limiting to the scope of the invention herein.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

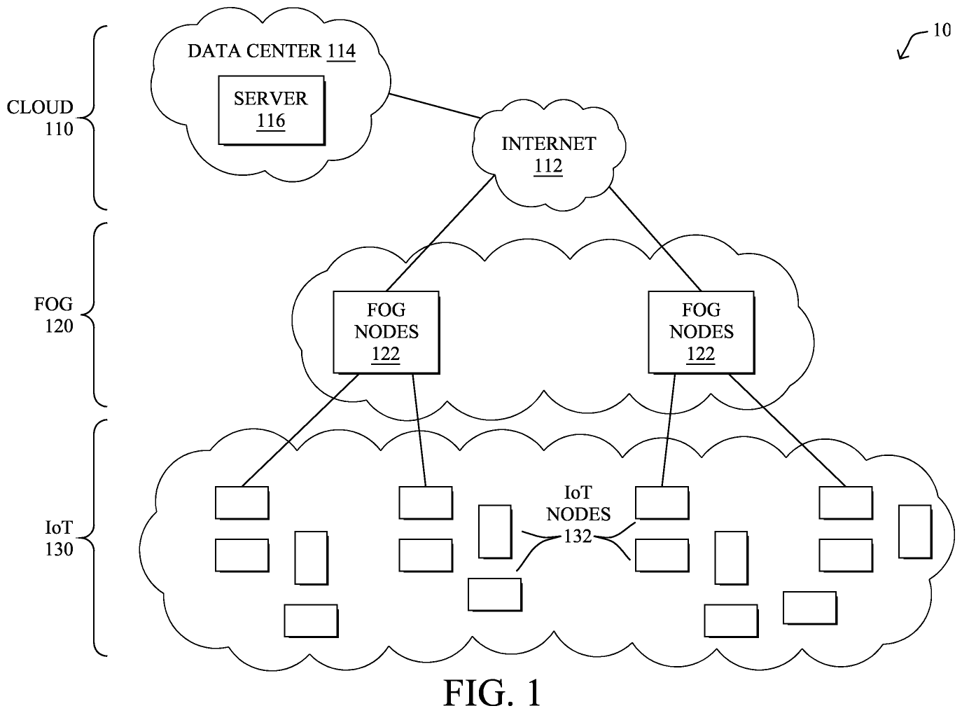

FIG. 1 is a schematic block diagram of an example simplified computer network (e.g., computer network 100) illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example computer network 100, three illustrative layers are shown. Namely, cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the computer network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

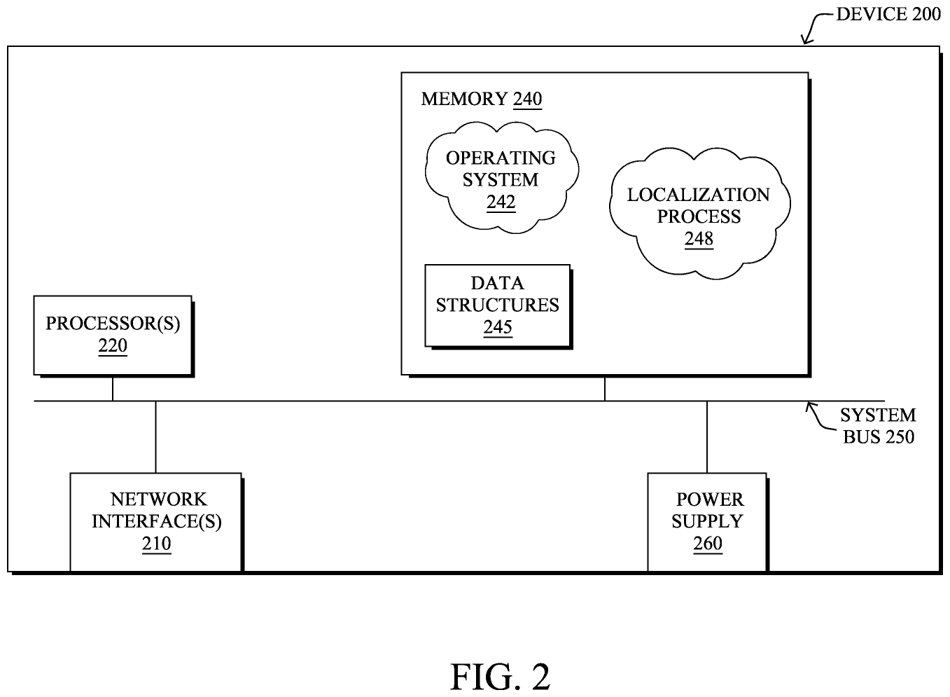

FIG. 2 is a schematic block diagram of an example node/device 200 (e.g., an apparatus) that may be used with one or more embodiments described herein. As shown, device 200 may comprise one or more of the communication interface(s) 210 (e.g., wired interfaces, wireless interfaces, etc.), at least one processor (e.g., processor 220), and a memory 240 interconnected by a system bus 250, as well as a power supply 260 (e.g., battery, plug-in, etc.).

Communication interface(s) 210 include the mechanical, electrical, and signaling circuitry for communicating data over a communication link. To this end, communication interface(s) 210 may be configured to transmit and/or receive data using a variety of different communication protocols, such as TCP/IP, UDP, etc. Note that the node/device 200 may have multiple different types of communication interface(s) 210, e.g., wireless and wired/physical connections, and that the view herein is merely for illustration.

The memory 240 comprises a plurality of storage locations that are addressable by the processor(s) (e.g., processor 220) and the communication interface(s) 210 for storing software programs and data structures associated with the embodiments described herein. The processor 220 may comprise necessary elements or logic adapted to execute the software programs and manipulate the data structures 245. An operating system 242, portions of which are typically resident in memory 240 and executed by the processor(s), functionally organizes the node by, inter alia, invoking network operations in support of software processors and/or services executing on the device. These software processors and/or services may comprise a localization process 248. Localization process 248 may be executable by node/device 200 to perform hierarchical map-based localization operations that facilitate identification and selective utilization of areas of an environment providing increased localization estimate accuracy thereby increasing the reliability and precision of localization systems.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

### Hierarchical Map-Based Localization

As noted above, while demand for high-precision localization systems in industrial settings is rapidly increasing, traditional approaches to localization continue to struggle to meet this demand and represent a bottleneck with respect to industrial automation. For example, mobile devices such as semi-autonomous robots in industrial environments and other ultra-reliable wireless backhaul mobile device deployments need to precisely determine their position in order to perform different operations.

Traditionally, such localization is based on wireless metrics such as received signal strength indicator (RSSI) data, fine time measurement (FTM), angle of arrival (AoA), ultra-wideband (UWB), and the like. However, these approaches face various constraints that that limit their efficacy across diverse conditions and locations in industrial environments. The challenges include signal degradation caused by obstacles like machinery and structures, interference from other wireless devices, and sensitivity to environmental factors. In complex industrial settings, reflections, multipath effects, and synchronization difficulties can compromise the precision of fine time measurements and angle of arrival calculations. Additionally, ultra-wideband technology, while offering high accuracy, may encounter performance variations due to signal absorption by materials present in different locations.

Unfortunately, when faced the increasing complexity of industrial environments and the increasing demand for evermore precise localization awareness to complete complex industrial operations, these traditional methods are proving insufficient to consistently provide high precision and reliability in mobile device localization across diverse industrial environments. Likewise, as home and other business environments are increasingly automated, similar barriers to mobile device localization are arising.

In contrast, the techniques described herein introduce a mechanism for a hierarchical map-based localization approach that is dynamically adaptable to different environments and conditions. These techniques can facilitate precision calibration of navigation operations by identifying areas in an environment where a robot can receive the highest accuracy localization measurements and constructing a hierarchical map that characterizes the environment accordingly.

Then, the hierarchical map can be used to diverting a mobile device from a predefined path to these higher measurement accuracy areas in order to receive these higher accuracy measurements and calibrate their navigation operations. This allows navigation operations that may be comparably lower precision and/or prone to precision degradation (e.g., inertial navigation operations, etc.) but are less resource intensive and/or dependent on pristine radio operating conditions to be utilized as a primary form of navigation in an industrial environment. With these techniques, precision among these traditionally lower accuracy navigation operations can be checked, corrected, and/or maintained via occasional calibration by higher accuracy localization measurements (e.g., wireless signal-based localization measurements) at areas of the environment most amenable to delivering those measurements.

Specifically, according to one or more embodiments of the disclosure as described in detail below, a method may comprise: determining a hierarchical map of localization measurement accuracy for an environment; determining a first location of a mobile device (e.g., robot) within the environment; causing the mobile device to navigate to a second location within the environment and selected based on the hierarchical map that provides increased localization measurement accuracy over the first location; and calibrating, based on a localization measurement for the mobile device acquired at the second location, navigation operations for future movements of the mobile device.

Illustratively, the techniques described herein may be performed by hardware, software, and/or firmware, such as in accordance with the localization process 248, which may include computer executable instructions executed by the processor 220 (or independent processor of communication interface(s) 210) to perform functions relating to the techniques described herein.

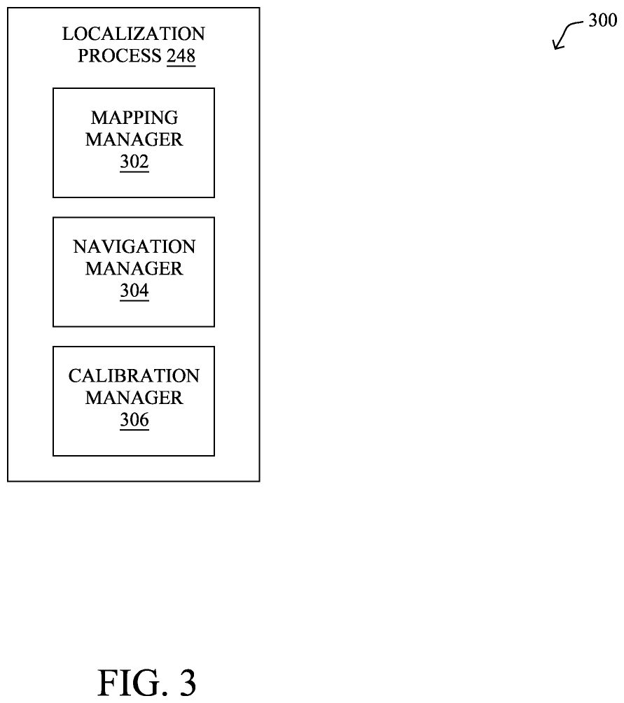

Operationally, FIG. 3 illustrates an example of an architecture 300 for hierarchical map-based localization among mobile devices. The architecture 300 may be deployed in an industrial environment with at least partial wireless communication network coverage. At the core of architecture 300 is localization process 248, which may be executed by one or more devices.

In various implementations, localization process 248 may be executed, in whole or in part, by a centralized controller for industrial operations. For example, the centralized controller may be a controller configured to manage multiple mobile devices and/or their operations within the environment (e.g., a centralized controller for managing a fleet of semi-autonomous robots, etc.). In some instances, the centralized controller may be a network controller for a wireless communication network such as an ultra-reliable wireless backhaul infrastructure.

Alternatively, or additionally, some or all of localization process 248 may be executed by another device in the environment (e.g., an access point of the wireless communication network, a mobile node, any device communicatively coupled to a wireless communication network, any device communicatively coupled to a mobile node, a sensor array, etc.). For example, localization process 248 may be executed, in whole or in part, by automated industrial equipment, autonomous mobile robots, amusement park vehicles, inventory picking and management vehicles, automated service robots, etc.

In a specific example, localization process 248 may be entirely or partially executed by a mobile robot configured to semi-autonomously perform material handling operations (e.g., order picking, etc.) along a predefined path (e.g., a picking route) in an industrial environment (e.g., a warehouse). In some implementations, localization process 248 may be executed as part of and/or in association with a Warehouse Execution Systems (WES) and/or Enterprise Resource Planning (ERP) systems.

As shown, localization process 248 may involve operations of mapping manager 302, navigation manager 304, and/or calibration manager 306. As would be appreciated, the functionalities of these components may be combined or omitted, as desired. In addition, these components may be implemented on a singular device or in a distributed manner, in which case the combination of executing device can be viewed as their own singular device for purposes of executing localization process 248.

During execution, mapping manager 302 may determine a hierarchical map of localization measurement accuracy measured and/or predicted across an environment. As previously noted, environments (e.g., industrial, home, business, etc.) are increasingly automated and densely populated with mobile nodes. Accurate localization awareness for these mobile nodes can be critical to their ability to complete operations within their environments.

For example, localization is a major component of many systems that use robots (e.g., fully autonomous, semi-autonomous, etc.) for various tasks. For instance, in an industrial environment such as a warehouse mobile robots may be deployed to semi-autonomously perform material handling operations (e.g., pick orders of goods and return them to a designated area) along a predefined path. In order to correctly retrieve/offload the specified goods, and to navigate to their locations, knowledge of the precise location (e.g., with a threshold degree of accuracy) of a robot needs to be identified and/or maintained throughout its operations.

In various implementations, mobile robots or other nodes in these environments may have a rough spatial understanding of their position within the environment. This understanding may include a positional awareness that may be precise enough to determine positions or areas in the environment that provide access to various accuracy level guarantees to perform ultra-wideband (UWB), fine time measurement (FTM), or other high precision localization operations but not reliably precise enough to reliably facilitate precision execution of their industrial purposes.

For example, mobile robots or other nodes may primarily rely on inertial navigation operations that only coarsely suggest where they are located within an environment and/or which may degrade in accuracy over the course of movement. For instance, the accuracy of an inertial navigation system may depend on the accuracy of its understanding of a starting position and/or the accuracy of its understanding of the effect of the robot's movements on its location. Unfortunately, while more precise localization techniques exist, many environments are not amendable to constant access to the resources involved in high precision localization operations. Hence, the reliance on techniques that provide only coarse positional awareness.

For example, various form factor restraints, power budget restraints, cost restraints, etc. may pose a limit to providing the mobile robots or other nodes with the computational and/or communication resources necessary to support the high precision localization operations. Additionally, environmental conditions (e.g., obstacles like machinery and structures, interference from other wireless devices, reflections, multipath effects, synchronization difficulties, signal absorption by materials present in different locations, and/or other environmental factors.) adverse to reliable execution of the high precision localization operations (e.g., localization based on wireless metrics such as received signal strength indicator (RSSI) data, fine time measurement (FTM), angle of arrival (AoA), ultra-wideband (UWB), and the like) are increasingly present in all environments and represent a growing barrier to supporting these operations.

To overcome the shortcomings associated with the coarse positional awareness without implausible modifications to the environment or mobile robot, mapping manager 302 determines a hierarchical map of localization measurement accuracy for the environment which can be leveraged to facilitate a best-of-both-worlds approach to localization awareness and/or maintenance.

This hierarchical map may include a logical map of the environment where the robot performs its industrial purpose. The hierarchical map may demarcate areas and/or positions within the environment that are hierarchically coded according to the historical and/or predicted accuracy of localization function measurements provided to the robot once in those areas and/or positions. For example, the hierarchical map may characterize areas and/or positions within the environment according to their relationship to hierarchical localization accuracy thresholds.

The relationship of each area and/or position to a given hierarchical localization accuracy threshold may be based on a determination of an accuracy or reliability of a localization measurement (e.g., e.g., a wireless signal-based localization measurement such as one or more of a received signal strength indicator (RSSI) measurement, an angle of arrival (AoA) measurement, a fine time measurement (FTM), or an ultra-wideband (UWB) based measurement) obtained and/or predicted for a robot at that area and/or position of the environment. The reliability and/or accuracy of a localization measurement for an area and/or position may be determined based on cross-referencing its measurements against other localization measurements/operations, cross-referencing its measurements against same/similar/different localization measurements of other robots or nodes, cross-referencing its measurements against historical data regarding localization measurements, computed confidence/strength assessments of its measurements, data fusion-based (e.g., computer-vision, optical tracking, LIDAR, inertial measurements, etc.) assessments of its measurements, triangulation involving other robots or nodes, etc.

The hierarchical map may be determined, compiled, maintained, and/or disseminated, in whole or in part, by a centralized controller (e.g., a network controller, a controller configured to generate the hierarchical map for dissemination to multiple robots within the environment, etc.), by a robot or plurality of robots operating in the environment, and/or by other nodes in the environment. For instance, a centralized controller may compile the hierarchical map based on the reliability and/or accuracy of one or more localization measurements from one or more mobile robots operating in the environment. For example, the centralized controller may compile the hierarchical map from localization measurement accuracy associated with an individual robot or group of robots while operating in the environment. The centralized controller may communicate the hierarchical map it has compiled to mobile robots and/or the centralized controller may utilize the hierarchical map to compute navigation instructions itself which it then communicates to the robots.

In various implementations, in addition to and/or rather than the controller providing the above map information to the robots, the hierarchical maps may be learned by the mobile robots themselves. In some instances, the robots may personalize the hierarchical maps received from the centralized controller. A mobile robot may compile and/or personalize the hierarchical map based on the reliability and/or accuracy of one or more localization measurements it has obtained while performing its operations in the environment and/or based on knowledge of the hierarchical accuracy thresholds corresponding to the hierarchical coding applied to each area and/or position in the hierarchical map.

In some instances, a fleet of mobile robots may work together to personalize and/or compile the hierarchical map rather than relying solely on the centralized controller for its provision. For example, each robot of a fleet of robots operating in an environment may learn and/or personalize the hierarchical map based on successive iterations of sharing information (e.g., localization measurement accuracy and/or reliability data) among one another. In some instances, this may be referred to as a “buddy” system of cooperative localization and/or map building.

During execution, navigation manager 304 may determine a first location of a mobile node (e.g., semiautonomous robot, etc.) within an environment. Determining the first location of the mobile node may include identifying where the first robot is currently located within the environment within the context of the hierarchical map. The determination may be made by a centralized controller, by a robot itself, and/or by communicatively coupled nodes.

This determination may be based on one or more of a variety of localization measurements/operations (e.g., wireless metric-based, computer-vision-based, optical tracking-based, LIDAR-based, inertial measurements-based, triangulation involving other robots or nodes, etc.). In some instances, these localization measurements/operations may be ascertained via a primary localization measurement technique employed with respect to the mobile node. The primary localization measurement technique may only deliver a coarse localization estimate (e.g., an inertial navigation-based localization estimation, a low accuracy wireless signal-based localization estimation, etc.). Ultimately, this primary localization measurement technique may be calibrated (e.g., by calibration manager 306) as described below using a secondary technique or an improved measurement by the primary technique that provides increased localization measurement accuracy obtained at a location providing increased localization measurement accuracy.

In addition, navigation manager 304 may, during execution, cause the mobile device to be navigated to a second location in the environment. The second location may be a location within the environment that provides increased localization measurement accuracy over the first location.

The second location may be selected by the centralized controller, by a robot itself, and/or by another node in the environment. The second location may be selected based on the hierarchical map. For instance, the second location may be selected based on the categorization of its localization measurement accuracy in the hierarchical map.

In various implementations, the second location may be selected based on localization measurement accuracy comparisons among positions. For example, the second location may be selected based on a hierarchical map-based comparison of a categorization of the localization measurement accuracy at the first determined location of the robot to a categorization of the localization measurement accuracy at other locations in the environment, the second location may be selected.

Various types of selection criteria may be applied when selecting the second location. For example, the second location may be selected based on a spatial relationship of the second location to the first location. For instance, the first location of the robot may be a location along an operational route of the robot. In order to maximize the operational efficiency of the robot and/or to minimize interference with the operations of other robots, the second location may be selected based on its proximity to the operational route and/or a next stop (e.g., where the robot will carry out a specific operation other than navigation such as a material handling operation) along the operational route of the robot. For example, the second location may be a location selected to keep the robot close to its operational route and/or ensure efficient/time saving navigation to a next stop while still achieving increased localization measurement accuracy. Additionally, or alternatively, the second location may be selected based on its proximity to the routes of other robots in the vicinity (e.g., staying out of the path of other robots at times when they will be traversing those positions to avoid interference, performing opportunistic operations for another robot, etc.).

In some implementations, the selection criteria applied to selection of the second location may include operational route path deviation (e.g., distance-based, time-based, resource-based, operational opportunity-based, etc.) thresholds. For example, a second location may be selected only when it is within a threshold distance from the operation route. Of course, the operational route path deviation thresholds may be dynamized such as by incorporating different threshold amounts of permitted operational route path deviation in association with different threshold amounts of localization measurement accuracy provided by the deviation.

For example, more operational route path deviation may be permitted (e.g., higher maximum deviation threshold) to achieve relatively higher localization measurement accuracy thresholds than is permitted to achieve relatively lower localization measurement accuracy threshold. That is, a robot may be permitted to deviate further to achieve substantially better measurement accuracy. This may be algorithmicized as one or more threshold deviation distances permitted to achieve one or more threshold localization accuracy improvements.

In various implementations, the second location may be selected based on the location (e.g., measured, current, future, predicted, planned, etc.) of other robots in the environment as it relates to achieving an increased localization measurement accuracy over the first location. For example, a first robot in the environment may be able to achieve localization measurements by leveraging one or more buddy robot(s) operating in the environment. For instance, triangulation of the first robot may be performed via one or more close by buddy devices (e.g., other robots in the same deployment and/or within communication range of the first robot). Likewise, buddy devices, once in communication range of the first robot, may be able to share localization data sufficient to provide the first robot with higher accuracy localization measurements.

Furthermore, close by buddy devices may be able to operate as communication relay devices to relay higher accuracy localization measurements from centralized controllers, other robots, other nodes, etc. that would otherwise be out of communication range of the first robot. The various selection criteria may be adapted to consideration of the localization measurement accuracy, spatial relationships, etc. involved in leveraging of the buddy devices for collaborative localization measurement acquisition.

In some instances, the second location may be selected and/or the robot navigation thereto may be caused responsive to a localization error and/or degradation being detected for the robot. For example, a robot may leverage data fusion (e.g., computer-vision-based localization measurements, wireless metric-based localization measurements, optical tracking-based localization measurements, LIDAR-based localization measurements, inertial localization measurements, triangulation involving other robots or nodes, multi-dot deployment signature-based localization measurements, etc.) to monitor its location while performing its operations. These measurements may be utilized to detect when the robot position awareness has degraded and/or become erroneous. For instance, a robot may utilize this data to determine checkpoints and “safe-precise rendezvous points” that serve as check marks to identify errors in its navigational operations (e.g., the robot is not where it understands itself to be, the robot has diverged from its operational route, etc.). In various implementations, once an error or degradation is detected, a selection of a second location and/or the instigation of robot navigation thereto may be triggered.

Selection criteria for the second location may vary based on the detected error or degradation. For example, a particular operational route path deviation threshold may be selected based on a level detected error or degradation. For instance, operational route path deviation thresholds may be increased or decreased for the second location based on the severity of the error or degradation. A robot may be permitted more operational route path deviation to arrive at a second location when its detected error or degradation is more severe and vice versa.

Instigation of robot navigation to the second location may be caused, in whole or in part, by the centralized controller and/or by the robot itself. For example, the centralized controller may compute and/or communicate navigation instructions to the first robot that are executable to cause the robot to navigate to the second location. Alternatively, and/or additionally, the robot can decide for itself to move to an area that offers better localization measurement accuracy and navigate accordingly. In addition, a given robot may opt to move a little to the right/left, to reach the best position (e.g., with a multi-dot signature of the deployment).

The navigation from the first location to the second location may be monitored and/or supplemented with course corrections from the robot itself, the centralized controller, other robots, other nodes, etc. However, the hierarchical map may characterize entire areas or regions of localization measurement accuracy that are much larger in size than any particular singular position in the environment. Consequently, a robot's coarse-grained, erroneous, and/or degraded locational awareness may still be sufficient to reach a second location that is a region of increased accuracy regardless of whether that location awareness could precisely or reliably reach an exact position within that region. That is the mobile robots or other nodes have a rough understanding of their position during navigational operations that is not precise enough for their industrial purposes (e.g., navigating to a precise location aligned with an item on a storage rack, etc.) but good enough to determine if their position provides good guarantees to perform UWB, FTM or other high precision localizations (e.g., what region of the environment they are in).

During execution, calibration manager 306 may calibrate navigation operations for future movements of a mobile node based on a localization measurement obtained for the node at the second location. Calibrating the navigational operations may include calibrating a navigational operation input such as a measurement of a mobile nodes current position, environmental mapping, etc. Alternatively, or additionally, calibrating the navigational operations may include calibrating how a mobile node navigates, how the location of the mobile node is tracked during navigation, etc.

For instance, calibrating the navigational operations may include adjusting the robot's internal mapping algorithms to account for any discrepancies observed between the expected and actual localization measurements. This calibration process may ensure that the robot's future path planning and decision-making are based on the most accurate and up-to-date information about its environment.

In various implementations, if the localization measurement indicates that the robot is moving faster or slower than expected, or deviating from its intended path, the calibration manager 306 might adjust the motor control algorithms to fine-tune the robot's speed and turning angles. Based on the new localization data, the calibration manager 306 may update the robot's internal models of the environment. This could involve refining the estimates of the positions of walls, obstacles, or specific zones within the warehouse that have unique characteristics affecting localization accuracy. The calibration process might also involve tweaking how different sensor inputs are weighted and fused together. For example, if the robot is in an area where UWB signals are strong and reliable, the calibration manager 306 might increase the reliance on UWB data over other sensors like RSSI or AoA.

Over time, inertial measurement units (IMUs) can experience drift. Calibration at the second location might involve resetting or recalibrating the IMU data to align with the newly acquired localization measurements. If certain localization methods (like FTM or AoA) are found to be more accurate in specific areas of the environment, the calibration manager 306 might dynamically alter the localization algorithm preferences depending on the robot's location in the environment.

The robot's internal map might be updated to reflect more precise information about certain areas, especially those with higher localization measurement accuracy or those where precise localization understanding is required for operational completion. This could involve increasing the resolution of the map or adding new features detected in these areas.

Hence, calibrating the navigational operations based on the localization measurement at the second location may involve a comprehensive adjustment of the robot's movement controls, sensor processing, internal mapping, and/or localization strategies. This may ensure that the robot operates with the highest possible accuracy and efficiency in its environment.

In various implementations, calibrating the navigational operations may include providing the mobile robot with a more accurate understanding of where it is located in the environment than it previously possessed. Then, any subsequent navigational operations may not need to be algorithmically modified, but rather are calibrated by virtue of then being based off of a more accurate starting location (e.g., inertial based navigation becomes more accurate based on a more precise understanding of where the mobile node is navigating from). Likewise, subsequent navigational operations may be calibrated by virtue of being bestowed with more accurate knowledge of there the mobile node is headed and/or the path it will be using to get there.

These techniques empower dynamic adaptation of the semi-autonomous operation of mobile devices to changes in the environment, in their localization accuracy, in the localization of other mobile devices, etc. For example, as the environment changes, these techniques provide a mechanism by which those changes can be recognized and/or corrected for through calibration.

This may facilitate high accuracy/reliability navigation and operational completion within minimal resource demands. In addition, it enables a robot to be intermittently and/or primarily run utilizing localization measurement techniques that traditionally only delivered a coarse localization estimate, but that can have their localization estimation accuracy and/or reliability substantially increased with occasional calibrations by more reliable and/or accurate localization measurement techniques.

For example, a robot may rely on inertial localization techniques while traversing its predefined operational route and/or performing its prescribed operations. Then, it may be caused to navigate to a second location where it may receive a higher precision wireless metric-based localization measurement by which it recalibrates its inertial localization system. Once calibrated, the robot may be caused to return to its operational route and perform its operational assignments utilizing its inertial localization system that can now navigate based off of a much more accurate understanding of its current position within the environment based off of the more reliable and/or accurate localization measurement.

While this example concerns calibration across different types of localization measurement techniques, it should be appreciated that this high-accuracy calibration may be accomplished through location-dependent improvements in the same localization measurement techniques as well. For example, as a navigational technique's accuracy degrades, the mobile node may be able to correct this degradation by visiting portions of the environment with high accuracy localization measurements to calibrate the technique's accuracy.

Also, data fusion (e.g., with computer-vision, etc.) may be leveraged to determine checkpoints and “safe-precise rendezvous points” that serve as check marks to identify errors. Then, inertial systems may be used on the device to determine its location in the rest of the deployment. Further, a map of degrading precision may be computed and/or maintained by each robot. In some variations, mobile robots may utilize K different links at the same time (multilink operation).

Therefore, the techniques herein aid in the localization of mobile nodes, such as semi-autonomous robots by identifying areas of a deployment that offer better/more accurate localization estimates than others. This allows for the nodes to navigate to the ‘best’ available locations, thereby increasing the accuracy, reliability, and success of localization systems.

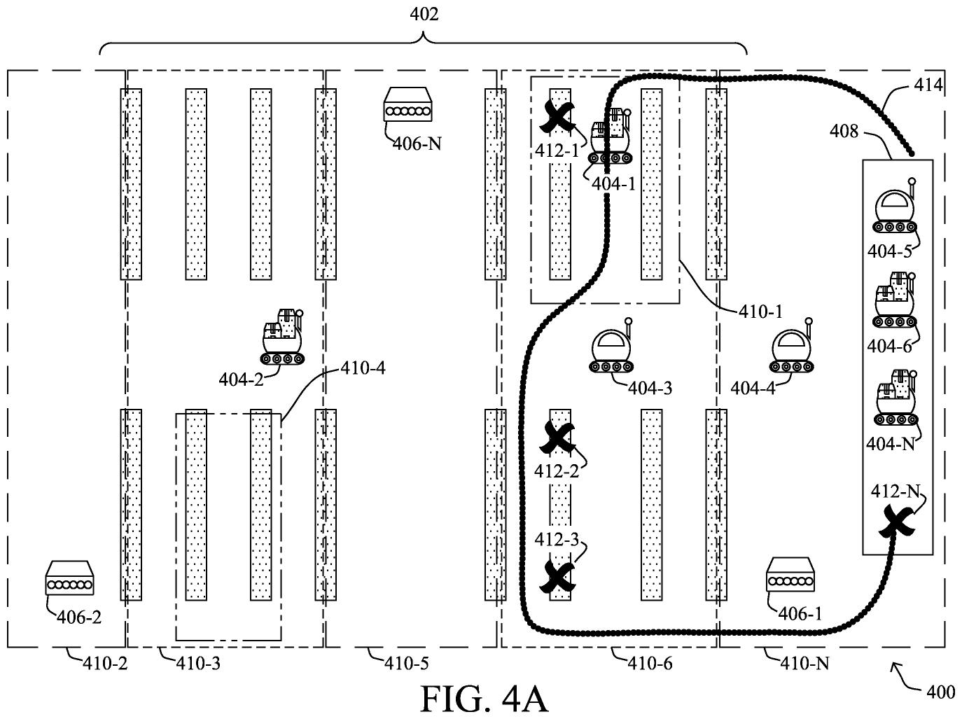

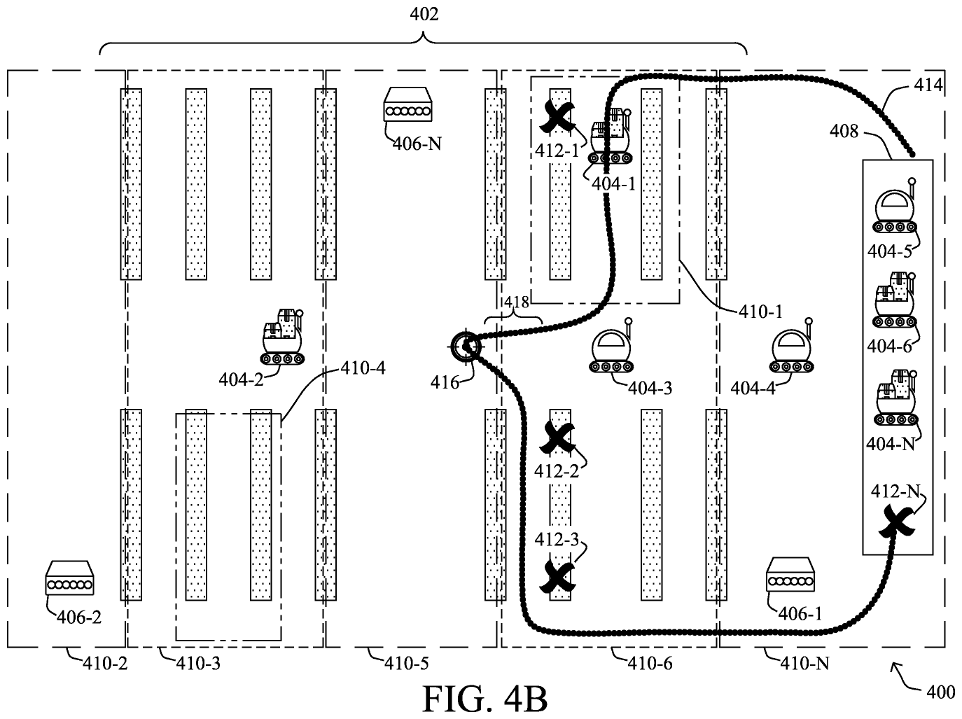

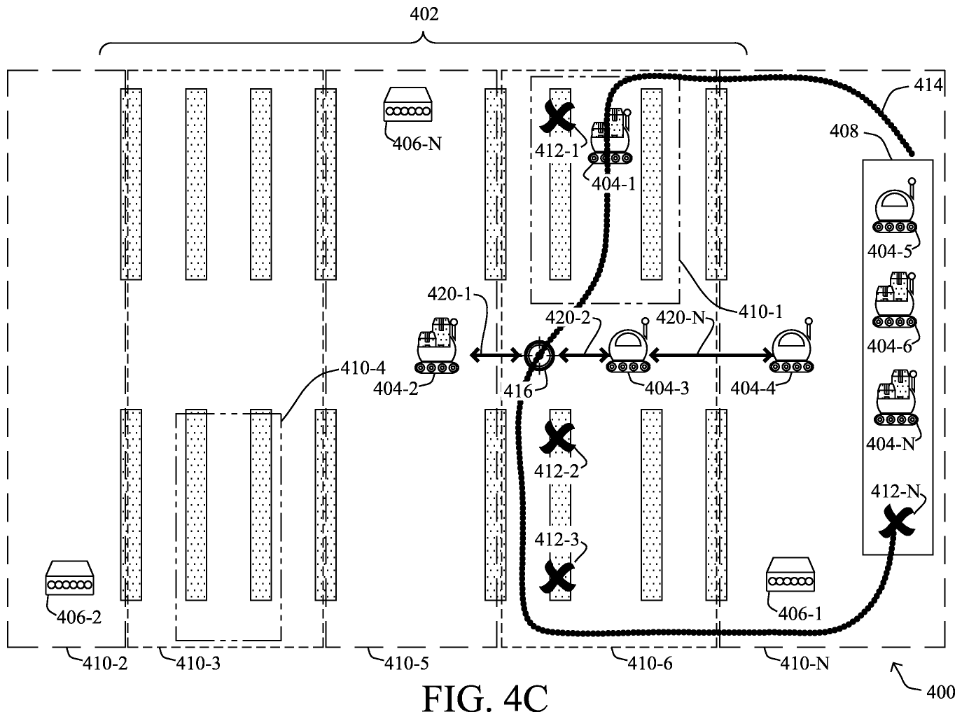

FIGS. 4A-4C illustrate examples of a hierarchical map of an environment 400 for hierarchical map-based localization among mobile devices in an industrial environment, according to various embodiments. For instance, environment 400 may be a warehouse, dock, post office, distribution center, or any indoor or outdoor location in which automated tasks may be performed (e.g., a location where items may be placed for storage and retrieved at a later time). In further embodiments, environment 400 may take the form of a vehicle, such as the cargo hold of a ship, a trailer of a truck, the hold of an aircraft, or the like.

In environment 400, a large density of mobile nodes 404 (e.g., 404-1 . . . 404-N) may be deployed and/or operating. For example, each of the mobile nodes 404 may be an autonomous mobile robot (AMR) configured to pick orders of goods from inventory racks 402 throughout the environment 400. The mobile nodes 404 may be configured to semi-autonomously perform industrial operations such as material handling operations at stops 412 (e.g., 412-1 . . . 412-N) along a predefined path 414 (e.g., a picking route) through the environment 400.

In some embodiments, the mobile nodes 404 may also include mechanisms to automatically load and/or unload items, such as forklifts, mechanical claws, or the like. In other embodiments, the mobile nodes 404 may require the assistance of human workers to load and unload items to and from the AMRs. In some instances, environment 400 may also include a pack-out area 408 that has been designated as the place at which the mobile nodes 404 are to unload their retrieved items.

In various embodiments, a wireless communication network may be deployed within environment 400. The wireless communication network may be deployed as an ultra-reliable wireless backhaul systems that may be configured to support radio communication configurations such as point-to-point, point-to-multipoint, and/or mesh configurations.

The wireless communication network may include access points (APs 406 (e.g., 406-1 . . . 406-N)) that wirelessly engage in data communication with any of the mobile nodes 404 that are associated to them. These APs 406 may receive data communications from mobile nodes 404 and pass these communications to the core of the wireless communication network and/or may send data communications from the network to any associated ones of the mobile nodes 404.

Each of the APs 406 may provide a wireless signal coverage area within environment 400. A wireless signal coverage area of each of the APs 406 may be an area within which that particular AP can reliably provide network connectivity to any of the mobile nodes 404 located therein.

Often, the wireless signal coverage areas of the APs 406 are not able to provide full coverage at threshold levels across the entirety of an environment 400 where they are deployed. There may be many reasons for this incomplete coverage including topography, object interference, signal interference, equipment setup errors/limitations, equipment degradation/failure, weather conditions, RF characteristics, etc.

Consequently, wireless signal-based localizations techniques that rely on wireless communication with these devices for localization measurements may be less accurate, reliable, and/or available across different areas of the environment 400. An accurate and reliable understanding of the location of the mobile nodes 404 can be critical to their ability to complete operations. For instance, in order to correctly retrieve the specified goods, and to navigate to their locations, knowledge of the precise location (e.g., with a threshold degree of accuracy) of a robot needs to be identified and/or maintained.

As described above, a process (e.g., localization process 248) may be executed by a device in order to bridge the knowledge gap between the coarse, degraded, and unreliable positional awareness achievable under current architectures and the precise positional awareness needed to accurately and reliably complete industrial processes without introducing implausible modifications to the environment 400, the mobile nodes 404, the wireless communication network, etc. As noted above, the process may be executed entirely and/or partially by a centralized controller communicatively integrated in the wireless communication network, an AP, a mobile node, in association with a Warehouse Execution System (WES), in association with an Enterprise Resource Planning (ERP) system, and/or any device communicatively coupled to the wireless communication network.

In FIG. 4A, a first mobile node 404-1 is illustrated performing industrial operations at stops 412 while navigating a predefined path 414. As outlined above, localization process 248 may be executed to determine a hierarchical map of localization measurement accuracy for environment 400. Determining the hierarchical map may include logically segmenting the environment 400 into areas 410 (e.g., 410-1 . . . 410-N). Each of the areas 410 may correspond to regions of environment 400 where a threshold level of localization measurement accuracy has been obtained and/or is predicted to be obtainable. When visualized, each of the areas 410 may be a pattern coded, color coded, or otherwise coded with indicators of their corresponding threshold level of localization measurement accuracy.

For example, a second area 410-2, a fifth area 410-5, and/or an Nth area 410-N may be areas of environment 400 are coded as regions where a first threshold level of localization measurement accuracy has been obtained and/or is predicted to be obtained by a colocalized mobile node. For instance, these areas may be portions of the environment 400 where wireless signal-based localization measurements received by the mobile nodes 404 provide a relatively highest or best level of localization accuracy.

A third area 410-3 and a sixth area 410-6 are coded as regions of environment 400 where a second threshold level of localization measurement accuracy has been obtained and/or is predicted to be obtained by a colocalized mobile node. For instance, these areas may be portions of the environment 400 where wireless signal-based localization measurements received by the mobile nodes 404 provide a relatively intermediate or acceptable level of localization accuracy.

A first area 410-1 and fourth area 410-4 are coded as regions of environment 400 where a third threshold level of localization measurement accuracy has been obtained and/or is predicted to be obtained by a colocalized mobile node. For instance, these areas may be portions of the environment 400 where wireless signal-based localization measurements received by the mobile nodes 404 provide a relatively lowest or unacceptable/unreliable level of localization accuracy.

These areas may be determined based on historical and/or predicted accuracy of localization function measurements provided to the robot while in those areas. The hierarchical map may be determined individually or by a combination of a particular mobile node, other mobile nodes in the environment 400, a controller, a wireless network component, etc.

A first location of the first mobile node 404-1 within the environment 400 and/or relative to the areas 410 may be determined. The first location may be a location where the first mobile node 404-1 is located and/or is supposed to be located within the environment 400. This determination may be made based on sensor data collected by the first mobile node 404-1, data from other mobile nodes, wireless signal communications, path plan data, environmental sensors, etc.

In FIG. 4B, a first mobile node 404-1 is illustrated being caused to navigate to a second location 416. As outlined above, localization process 248 may be executed to cause the first mobile node 404-1 to navigate to the second location 416, selected based on the hierarchical map. Specifically, the second location 416 may be a location within the environment 400 that provides increased localization measurement accuracy over the first location.

In this example, the first mobile node 404-1 is caused to navigate from a first location in a first area 410-1 providing a lowest or unacceptable/unreliable level of localization accuracy to a second location 416 in a fifth area 410-5 that provides a highest or best level of localization accuracy in the environment 400. In the example illustrated in FIG. 4B, the first mobile node 404-1 is caused to navigate to the second location 416 via a path detour 418 that takes it off of the predefined path 414 to reach the second location 416.

Once at the second location 416, first mobile node 404-1 may acquire a localization measurement. This localization measurement acquired at the second location 416 may be utilized to calibrate the navigation operations for its future movements. For example, the localization measurement acquired at the second location 416 may be utilized to calibrate the coarse navigation operations to be utilized in navigating the remainder of the predefined path 414 and/or performing material handling operation at the remaining stops (412-2 . . . 412-N). Of course, following calibration at the second location 416 the first mobile node 404-1 may be rerouted along a different path and/or along a partially modified version of the predefined path 414 to take advantage of its new position relative to proximate operation opportunities and/or to take on a portion of a route of another mobile node that may undergo calibration.

In FIG. 4C, a first mobile node 404-1 is illustrated being caused to navigate to a second location 416 within the environment 400 that provides increased localization measurement accuracy over the first location. The second location 416 selected based on the hierarchical map is a location within environment 400 that provides increased localization measurement accuracy over the first location.

In this example, the first mobile node 404-1 is caused to navigate from a first location in a first area 410-1 providing a lowest or unacceptable/unreliable level of localization accuracy to a second location 416 in a sixth area 410-6 that provides intermediate or acceptable level of localization accuracy. In the example illustrated in FIG. 4C, the first mobile node 404-1 is caused to navigate to the second location 416 along the predefined path 414.

In contrast to FIG. 4B, however, in the example illustrated in FIG. 4C the first mobile node 404-1 is caused to establish communication links 420 (e.g., 420-1 . . . 420-N) with buddy mobile nodes (e.g., second mobile node 404-2, third mobile node 404-3 and fourth mobile node 404-N) once it reaches the second location 416. These communication links may then be utilized to acquire a higher accuracy localization measurement of the first mobile node 404-1 at the second location 416. This may include the buddy devices actively participating in the localization measurement (e.g., triangulation) and/or acting as communication relays for the localization measurements.

In an extension of the buddy mobile node collaboration technique outlined above, other mobile nodes may be caused to navigate to other locations in environment 400 to facilitate the buddy mobile node collaboration. For example, second mobile node 404-2 may be caused to navigate from a location in third area 410-3 to a location in fifth area 410-5 to facilitate acquisition of a more accurate localization measurement for first mobile node 404-1. This may include diverting second mobile node 404-2 from its predefined path. In some instances, second mobile node 404-2 may recalibrate it's own navigation operations while collaborating in the calibration of first mobile node 404-1.

Again, this localization measurement acquired at the second location 416 may be utilized to calibrate the navigation operations for the future movements of first mobile node 404-1. For example, the localization measurement acquired at the second location 416 may be utilized to calibrate the coarse navigation operations to be utilized in navigating the remainder of the predefined path 414 and/or performing material handling operation at the remaining stops (412-2 . . . 412-N).

In various implementations, a degradation or error in the accuracy or reliability of the localization of the first mobile node 404-1 may be detected. For example, the position where first mobile node 404-1 is or understands itself to be may not be aligned with the position where the first mobile node 404-1 actually is or is supposed to be. This error or degradation may trigger execution of all or part of the localization process 248. Alternatively, execution of the localization process 248 may be performed periodically or otherwise triggered.

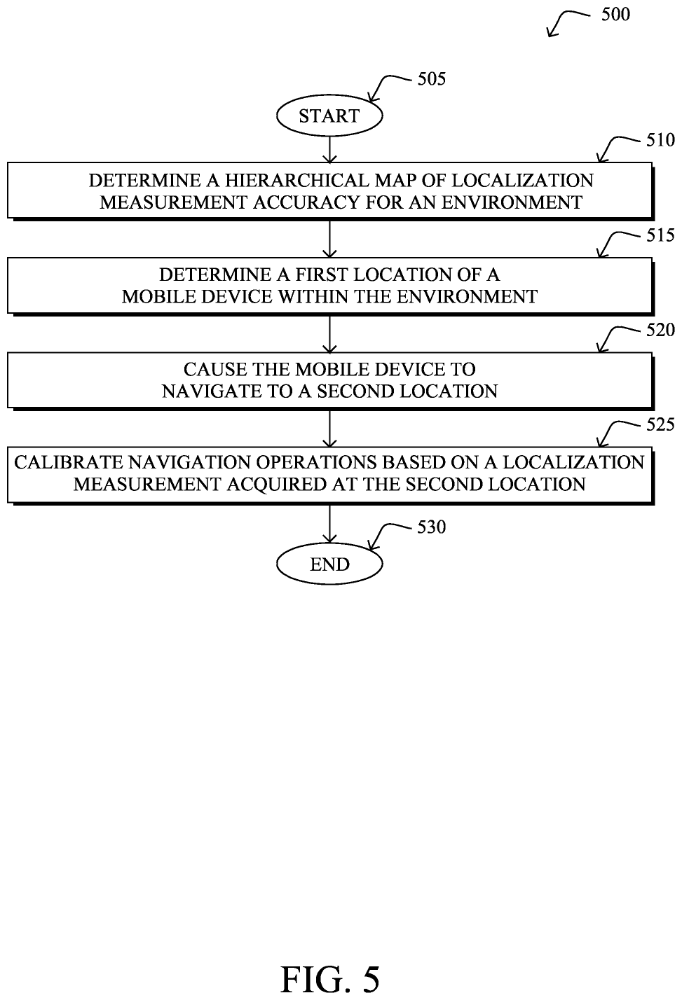

FIG. 5 illustrates an example simplified procedure for hierarchical map-based localization, in accordance with one or more implementations described herein. For example, a non-generic, specifically configured device (e.g., device 200) may perform procedure 500 by executing stored instructions (e.g., localization process 248).

The procedure 500 may start at step 505, and continues to step 510, where, as described in greater detail above, a hierarchical map of local measurement accuracy for an environment may be determined. The hierarchical map of localization accuracy may be based on an accuracy of a wireless signal-based localization measurement at each of a plurality of locations in the environment. For example, the wireless signal-based localization measurement may include one or more of a received signal strength indicator measurement, an angle of arrival measurement, a fine time measurement, or an ultra-wideband based measurement.

In various implementations, the hierarchical map of localization measurement accuracy may be based on dynamically updated estimates of localization accuracy maintained by the mobile device (e.g., robot) during deployment. Additionally, the hierarchical map of localization measurement accuracy may be collaboratively determined by the robot through successive iterations of sharing data with other robots.

In some instances, a centralized controller may be configured to generate the map for dissemination to multiple robots within the environment. The robot may receive the hierarchical map of localization measurement accuracy from the centralized controller.

At step 515, a first location of a robot within the environment may be determined. The robot may be configured to semi-autonomously perform material handling operations along a predefined path. The first location of the robot within the environment may be along the predefined path and the second location within the environment is off the predefined path.

As detailed above, at step 520, the robot may be caused to navigate to a second location within the environment. The second location may be selected based on the hierarchical map. The second location may be a location the provides increased localization measurement accuracy over the first location.

For example, the second location within the environment may be selected from among a plurality of locations in the environment that provide increased localization measurement accuracy over the first location based on a proximity of the second location to the predefined path. In some instances, the second location may be selected further based on a location of a second robot in the environment. The increased localization measurement accuracy at the second location involves communication with the second robot.

At step 525, navigation operations for the future movements of the robot may be calibrated. The calibration may be based on a localization measurement for the robot acquired at the second location. The localization measurement for the robot acquired at the second location may be a wireless signal-based localization measurement and/or the navigation operations may include inertial localization operations to determine a location of the robot in the environment during the future movements of the robot.

In some instances, the robot may be caused to navigate to the second location responsive to a determination that localization accuracy of the robot has degraded below a threshold accuracy. The determination that the localization accuracy of the robot has degraded below the threshold accuracy may be based on analysis of checkpoints in the environment.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism to facilitate the precise localization of mobile nodes by identifying areas of a deployment that offer better/more accurate localization estimates than others and/or leveraging those greater precision measurement to calibrate future navigation operations. This allows for the nodes to be navigated to locations where high-quality localization measurements can be achieved, thereby increasing the accuracy, reliability, and success of localization systems. This can facilitate a mechanism whereby robots would move to the best area for localization and then track-back the previous location (and/or next ones) via inertial systems.

These techniques may also incorporate the creation of degrading precision maps for each robot and their reported location, the use of safe-precise rendezvous points, and/or buddy cooperation for localization tracking. In all, these techniques can facilitate a dramatic increase in localization awareness among semi-autonomous mobile nodes without a corresponding increase in localization measurement resources. This can directly translate to an increase in operational efficiency and success in processes performed by these nodes.

While there have been shown and described illustrative embodiments that provide for hierarchical map-based localization, it is to be understood that various other adaptations and modifications may be made within the spirit and scope of the embodiments herein. For example, while certain embodiments are described herein with respect to using a single mobile node, the architectures are not limited as such and may include multiple mobile nodes operating collectively and/or in phases, in other embodiments. In addition, while certain security protocols and approaches are described, such as RSSI, AoA, FTM, UWB, etc., other suitable protocols may be used, accordingly. Also, while the term “robot” has been used throughout the present disclosure, other mobile devices may be used herein, such as autonomous vehicles, drones, or any device that may be controlled based on localization accuracy information as described herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining, by a device, a hierarchical map of localization measurement accuracy for an environment;
determining, by the device, a first location of a mobile device within the environment;
causing, by the device, the mobile device to navigate to a second location within the environment and selected based on the hierarchical map that provides increased localization measurement accuracy over the first location; and
calibrating, by the device and based on a localization measurement for the mobile device acquired at the second location, navigation operations for future movements of the mobile device.

2. The method as in claim 1, further comprising:
receiving, by the mobile device, the hierarchical map of localization measurement accuracy from a centralized controller, wherein the centralized controller is configured to generate the hierarchical map for dissemination to multiple mobile devices within the environment.

3. The method as in claim 1, wherein the hierarchical map of localization measurement accuracy is collaboratively determined by the mobile device through successive iterations of sharing data with other mobile devices.

4. The method as in claim 1, wherein the hierarchical map of localization measurement accuracy is based on dynamically updated estimates of localization accuracy maintained by the mobile device during deployment.

5. The method as in claim 1, wherein the hierarchical map of localization accuracy is based on an accuracy of a wireless signal-based localization measurement at each of a plurality of locations in the environment.

6. The method as in claim 5, wherein the wireless signal-based localization measurement includes one or more of a received signal strength indicator measurement, an angle of arrival measurement, a fine time measurement, or an ultra-wideband based measurement.

7. The method as in claim 1 wherein the mobile device is configured to semi-autonomously perform material handling operations along a predefined path.

8. The method as in claim 7, wherein the first location of the mobile device within the environment is along the predefined path and the second location within the environment is off the predefined path.

9. The method as in claim 7, wherein the second location within the environment is selected from among a plurality of locations in the environment providing increased localization measurement accuracy over the first location based on a proximity of the second location to the predefined path.

10. The method as in claim 1, wherein the second location is selected further based on a location of a second mobile device in the environment.

11. The method as in claim 10, wherein increased localization measurement accuracy at the second location involves communication with the second mobile device.

12. The method as in claim 1, wherein the localization measurement for the mobile device acquired at the second location is a wireless signal-based localization measurement and wherein the navigation operations include inertial localization operations to determine a location of the mobile device in the environment during the future movements of the mobile device.

13. The method as in claim 1, wherein the mobile device is caused to navigate to the second location responsive to a determination that localization accuracy of the mobile device has degraded below a threshold accuracy.

14. The method as in claim 13, wherein the determination that the localization accuracy of the mobile device has degraded below the threshold accuracy is based on analysis of checkpoints in the environment.

15. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a hierarchical map of localization measurement accuracy for an environment;
determine a first location of a mobile device within the environment;
cause the mobile device to navigate to a second location within the environment and selected based on the hierarchical map that provides increased localization measurement accuracy over the first location; and
calibrate, based on a localization measurement for the mobile device acquired at the second location, navigation operations for future movements of the mobile device.

16. The apparatus as in claim 15, wherein the hierarchical map of localization accuracy is based on an accuracy of a wireless signal-based localization measurement at each of a plurality of locations in the environment and wherein the wireless signal-based localization measurement includes one or more of a received signal strength indicator measurement, an angle of arrival measurement, a fine time measurement, or an ultra-wideband based measurement.

17. The apparatus as in claim 15, wherein the localization measurement for the mobile device acquired at the second location is a wireless signal-based localization measurement and wherein the navigation operations include inertial localization operations to determine a location of the mobile device in the environment during the future movements of the mobile device.

18. The apparatus as in claim 15, wherein the mobile device is configured to semi-autonomously perform material handling operations along a predefined path and wherein the first location of the mobile device within the environment is along the predefined path and the second location within the environment is off the predefined path.

19. The apparatus as in claim 15, wherein the second location is selected further based on a location of a second mobile device in the environment and wherein increased localization measurement accuracy at the second location involves communication with the second mobile device.

20. A tangible, non-transitory, computer-readable medium storing program instructions that cause a device to execute a process comprising:
determining a hierarchical map of localization measurement accuracy for an environment;
determining a first location of a mobile device within the environment;
causing the mobile device to navigate to a second location within the environment and selected based on the hierarchical map that provides increased localization measurement accuracy over the first location; and
calibrating, based on a localization measurement for the mobile device acquired at the second location, navigation operations for future movements of the mobile device.
